(19) United States
(12) Patent Application Publication
(10) Pub. No.: US 2016/0314948 A1
(43) Pub. Date: Oct. 27, 2016

(54) THERMIONIC POWER SUPPLY GENERATION UNIT

(71) Applicant: WEIGUO ZHANG, JINAN (CN)

(72) Inventor: WEIGUO ZHANG, JINAN (CN)

(21) Appl. No.: 15/104,234

(22) PCT Filed: Dec. 1, 2014
(86) PCT No.: PCT/CN2014/001077

§ 371 Date: Jun. 13, 2016

(30) Foreign Application Priority Data
Dec. 26, 2013 (CN) 201320867004.0

(51) Int. Cl. H01J 45/00

(52) U.S. Cl. CPC H01J 45/00

(57) ABSTRACT

A thermionic power generation unit applied to the field of nuclear energy, firepower, and solar energy power generation comprises multiple thermionic receiving and sending mixed electrodes and a last-stage receiving electrode. The multiple thermionic receiving and sending mixed electrodes are serially connected in turn, and then connected with the last-stage receiving electrode in series. The work temperature of the receiving and sending mixed electrodes of the thermionic power generation unit is same or close to that of the receiving electrode. The needed temperature of the heat source is relatively low, and the loss of heat energy is low. The device has the characteristics of simplification, economy, efficiency and security.

### TECHNICAL FIELD

The present invention pertains to the field of thermal power generation technologies, relates to a static thermoelectric conversion device, and more particularly, to a thermionic power generation unit applied to the field of nuclear energy, firepower, and solar energy power generation.

### BACKGROUND OF THE INVENTION

Although it is no more than one hundred years for people to use electric power on a large scale, application of various power generation apparatuses that are based on a thermoelectric conversion efficiency of about 4%-35% and are lack of mature and high-efficiency technologies to acquiring nuclear power and solar power on a large scale results in a sharp decrease of fossil energy accumulated since billions of years on the earth. In the face of on the verge of depletion of fossil energy and increasing deterioration of the natural environment, we are in urgent need of raising the level of power generation technologies, which in turn can use solar energy and nuclear energy resources on a large scale and reduce or even stop consumption of non-renewable fossil energy. This is the mainstream and the direction of energy conservation and emission reduction on a large scale in the present-day world.

A basic structure of an existing thermionic power supply consists of four indispensable components: a high temperature heat source, a high work function emitting electrode, a low work function receiving electrode, and a temperature-reducing device. Cesium vapor is filled between the emitting electrode and the receiving electrode. The working principle is as below: the high temperature heat source heats the emitting electrode and knocks thermoelectron out, the thermoelectron flies to the receiving electrode under the action of interelectrode contact potential difference, the receiving electrode captures the thermoelectron and maintains a lower temperature by means of a heat-extraction device. In this way, an electric potential difference is formed between the emitting electrode and the receiving electrode. An output voltage U satisfies that: interelectrode electronic potential difference=work function of emitting electrode material-work function of receiving electrode material-kinetic energy loss of the thermoelectron during transportation, namely:

Ue=Ø_{E}−Ø_{C}−E_{L}

where U is interelectrode open-circuit voltage, e is electron charge, Ø_{E} is the work function of emitting electrode material, Ø_{c} is the work function of the receiving electrode material, and E_{L} is kinetic energy loss of the thermoelectron during transportation.

The thermionic power supply designed according to the foregoing formula and principle: the work function of the emitting electrode material may only be greater than that of the receiving electrode material, namely, Ø_{E}>Ø_{C}. Otherwise, the output voltage may be zero or even a negative number. The work function of the emitting electrode is greater and the operating temperature is very high, but the receiving electrode shall work at a low-temperature environment. Therefore, a great temperature difference that is maintained by heat dissipation occurs between two adjacent electrodes, which may lead to dissipation of a great deal of heat energy instead of conversion into electric energy, with an actual thermoelectric conversion efficiency less than 6%. In addition, the single-power generating capacity is small, the output voltage is low, the power source structure and the operating condition are complex and the cost is high. Therefore there exists many problems interfering with commercial application. As a result, this kind of power supply has not been popularized for many years.

### SUMMARY OF THE INVENTION

In order to solve the foregoing technical problems, the present invention adopts a new thermionic thermoelectric conversion theory to deny the classic concept of contact potential difference in physics, restates a surface potential barrier feature of a metal conductor, puts forward the concept of phase potential difference, thoroughly denies the working principle of the existing thermionic power supply and puts forward a new formula for computing a voltage of a thermionic power supply, thereby constructing a new-type thermionic generating apparatus completely different from the existing thermionic power supply. The new-type thermionic generating apparatus has a very simple structure and operating condition, and a thermoelectric conversion efficiency obviously higher than that of the existing thermionic power supply.

The present invention is based on such a new-type thermionic thermoelectric conversion theory as below:

The new thermionic thermoelectric conversion theory denies the classic concept of contact potential difference in physics, namely, the contact potential difference does not exist, and the contact potential difference is impossible to do work. The new thermionic thermoelectric conversion theory reinterprets the surface potential barrier feature of a metal conductor, namely, an electric double layer of a metal surface is just like a fence built by using local materials, and inside and outside of the fence have the same height from the ground. Although the electric double layer of the metal surface can prevent internal electrons from escaping, it is not a potential difference. Phases of two meals do not change no matter whether they contact or not. Therefore, fermi levels of the two meals will not be unified. Phase potential difference resulted from material characteristics exists between the emitting electrode and the receiving electrode. Peltier heat is a result of doing work by phase potential difference. A key factor for power generation of the thermionic power supply is the initial kinetic energy of thermion. And escape velocity of effective thermion contributes to loop current. Therefore, the working principle of the existing thermionic power supply is thoroughly denied, and a formula of an open-circuit voltage of a new thermionic power supply is put forward.

The formula of a voltage of the thermionic power supply: Ue=E_{M}=ƒ(T, E_{f0})

where U is interelectrode open-circuit voltage, e is electron charge, E_{f0} is a fermi level of the emitting electrode, E_{M} is average maximum kinetic energy of runaway thermion, and T is the operating temperature of the emitting electrode.

The new theory makes it clear that the thermoelectric conversion principle and condition are different from those of the existing thermionic power supply: the work function of the emitting electrode is smaller than that of the receiving electrode, and the operating temperature of the emitting electrode may be equal to or greater than that of the receiving electrode.

The working principle of the new-type thermionic power supply generation unit is briefly introduced as below:

The new-type thermionic power supply generation unit includes two kinds of electrodes: a transceiving mixed electrode and a last-stage receiving electrode. The last-stage receiving electrode is made from a high-melting-point conductor having higher work function and lower capability of thermionic emission; the thermionic transceiving mixed electrode is used as the emitting electrode and the intermediate electrode; the thermionic transceiving mixed electrode uses the high-melting-point conductor having higher work function as a receiving electrode substrate, on a structural surface that is of the receiving electrode substrate and that needs thermionic emission, low-work-function material is employed for building a surface of the emitting electrode that is easy of thermionic emission. Material adopted by the receiving electrode substrate of the thermionic transceiving mixed electrode and material adopted by the surface of the emitting electrode meet the following condition: Ø_{C}>Ø_{E}, where Ø_{C} is work function of the material of the receiving electrode substrate of the thermionic transceiving mixed electrode, and Ø_{E} is work function of the material of the surface of the emitting electrode of the thermionic transceiving mixed electrode.

The high temperature heat source may directly or indirectly replenish various electrodes with heat and make all the electrodes maintain a certain high temperature. The thermionic transceiving mixed electrode and the receiving electrode may work at the same or similar temperature, or work at temperature gradients, from high to low successively, where various thermionic transceiving mixed electrodes and the receiving electrode exist, or various thermionic transceiving mixed electrodes work at the same temperature, and the receiving electrode works under a condition where the temperature is relatively lower. All the foregoing thermionic transceiving mixed electrodes are arranged inside the same insulated shell with no need for temperature reduction or heat extraction. An inner side of the receiving electrode is adjacent to the transceiving mixed electrode, and the outer side of the receiving electrode needs to meet requirements for dissipating heat toward outside the insulated shell where heat dissipation is controllable to ensure that the operating temperature of the last-stage receiving electrode is not higher than that of other transceiving mixed electrodes by means of a small quantity of temperature reduction or heat extraction. Heat of the last-stage receiving electrode mainly comes from impact heat of thermionic current, Peltier heat and heat radiated by an intermediate electrode to the last-stage receiving electrode. The object of the thermionic transceiving mixed electrode maintaining a high temperature is to achieve thermionic emission so that heat energy is converted into electric potential energy by way of thermionic emission. The operating temperature of the last-stage receiving electrode shall be close to but not higher than the temperature of the transceiving mixed electrode, with the purpose of reducing heat radiated by its adjacent thermionic transceiving mixed electrode to the last-stage receiving electrode, and further reducing heat loss.

The technical solution of the present invention is: the thermionic power supply generation unit consists of five components: a high temperature heat source, an insulated shell, a plurality of transceiving mixed electrodes, a receiving electrode and a heat-dissipation apparatus. The thermionic power generation unit includes m thermionic transceiving mixed electrodes and a last-stage receiving electrode. The m thermionic transceiving mixed electrodes are connected in series with each other successively, and then are connected in series with the last-stage receiving electrode. Namely, a thermoelectric conversion component of the thermionic power generation unit consists of n electrodes in total connected in series with each other successively: a first-stage thermionic transceiving mixed electrode, a second-stage thermionic transceiving mixed electrode, a third-stage thermionic transceiving mixed electrode, a fourth-stage thermionic transceiving mixed electrode, an m-stage thermionic transceiving mixed electrode and the last-stage receiving electrode, where m is a natural number, and n=m+1.

The thermionic transceiving mixed electrode includes: (1) a substrate: made from a high-melting-point conductor having higher work function; (2) a surface of the emitting electrode at one side of the substrate: the surface of the emitting electrode is made from cathode material, and a structural surface, of the transceiving mixed electrode substrate, that needs thermionic emission is subject to a surface treatment to reduce work function so that the surface becomes the surface of the emitting electrode that is easy of thermionic emission. The last-stage receiving electrode is an electrode made from a high-melting-point conductor having higher work function.

The thermionic transceiving mixed electrode and the last-stage receiving electrode are arranged inside the insulated shell, and the last-stage receiving electrode meets requirements for dissipating heat toward outside the insulated shell where heat dissipation is controllable to ensure that the operating temperature of the last-stage receiving electrode is not higher than that of other transceiving mixed electrodes.

The material adopted by the receiving electrode substrate of the thermionic transceiving mixed electrode and the material adopted by the surface of the emitting electrode meet the following condition: Ø_{C}>Ø_{E}, where Ø_{C} is the work function of the material of the receiving electrode substrate of the thermionic transceiving mixed electrode, and Ø_{E} is the work function of the material of the surface of the emitting electrode of the thermionic transceiving mixed electrode.

The high-melting-point conductor having higher work function is made from W, Mo, Ta, Ni, Pt, Nb, Re, C or P-type semiconductor materials.

The cathode material used as the surface of the lower work function emitting electrode is selected from oxide cathode material, atomic film cathode material, thorium-tungsten cathode material, rare earth-molybdenum cathode material or rare earth-tungsten-based scandium-type dispenser cathode material.

A thermionic power supply comprising the thermionic power supply generation unit includes: a thermoelectric conversion device having larger power formed by a plurality of thermionic power supply generation units connected in series or in parallel with each other.

The beneficial effects of the present invention reside in that:

1. The operating temperature of the transceiving mixed electrode of the thermionic power supply in the present invention is far lower than that of the emitting electrode of the existing thermionic power supply so that heat source requirements for thermal power generation are significantly reduced. Many heat sources may be used to generate power, for example, nuclear fuel, solar energy collection, thermal power or the like;

2. The operating temperature of the receiving electrode of the thermionic power supply in the present invention is the same or similar to that of the transceiving mixed electrode, with the equipment processing difficulty significantly reduced and the equipment operating conditions significantly improved, so that the new-type thermionic power supply has the advantages of lower cost and longer service life;

3. The operating temperature of the receiving electrode of the thermionic power supply in the present invention may maintain a high-temperature status only by very few heat dissipation, with less heat loss and high thermoelectric conversion efficiency; the thermoelectric conversion efficiency of the existing thermionic power supply is below 10%, however, the theory limit of the thermoelectric conversion efficiency of the thermionic power supply in the present invention may reach above 80%, and the utility efficiency may reach above 50%; and

4. The synthermal operating conditions of the electrodes and adiabatic structure of the housing make the structure of the power supply simple and reliable, which is beneficial to ensuring the safety of nuclear power.

### BRIEF DESCRIPTION OF DRAWINGS

FIG. 1 is the thermionic transceiving mixed electrode;

FIG. 2 is a structural diagram of the thermionic power generation unit, where

1: the thermionic transceiving mixed electrode; 2: the receiving electrode substrate of the transceiving mixed electrode; 3: the surface of the emitting electrode of the transceiving mixed electrode; 4: the first-stage thermionic transceiving mixed electrode; 5: the second-stage thermionic transceiving mixed electrode; 6: the third-stage thermionic transceiving mixed electrode; 7: the fourth-stage thermionic transceiving mixed electrode; 8: the m-stage thermionic transceiving mixed electrode; 9: the last-stage receiving electrode; 10: the insulated shell; 11: a wire; 12: a load; 13: the high temperature heat source; 14: heat replenished to electrodes; 15: Peltier heat and impact heat q; 16: loop current; 17: the heat-dissipation apparatus.

### DETAILED DESCRIPTION OF THE EMBODIMENTS

The following describes the present invention in detail by reference to accompanying drawings.

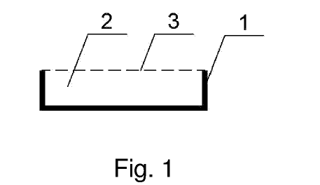

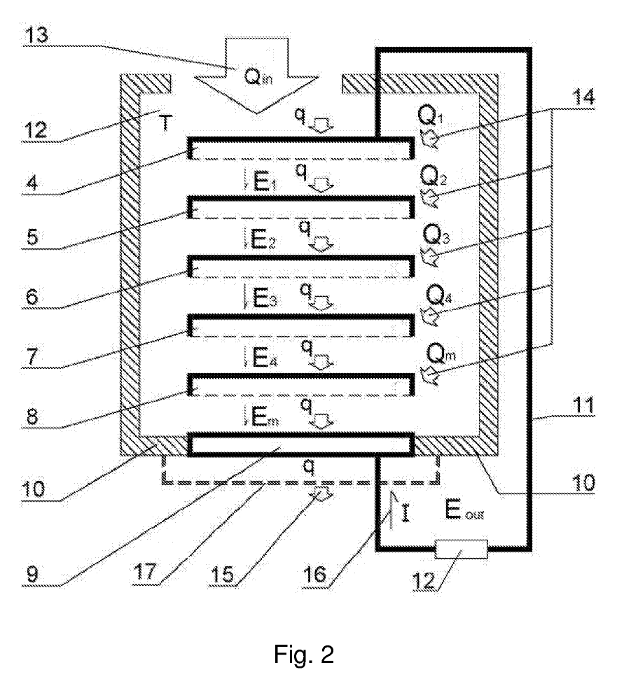

Referring to FIG. 1 to FIG. 2: the present invention includes m thermionic transceiving mixed electrodes 1 and a last-stage receiving electrode 9, the m thermionic transceiving mixed electrodes 1 are connected in series successively, and then are connected in series with the last-stage receiving electrode 9, where m is a natural number.

The thermionic transceiving mixed electrode 1 includes: (1) the substrate 2 is made from a high-melting-point conductor having higher work function (Ø_{C}); (2) the surface 3 of the emitting electrode at one side of the substrate 2 is made from cathode material having lower work function (Ø_{E}) so that the surface is easy of thermionic emission and it meets Ø_{C}>Ø_{E}; the last-stage receiving electrode 9 is made from a high-melting-point conductor having higher work function (Ø_{C}).

The high-melting-point conductor having higher work function is made from W, Mo, Ta, Ni, Pt, Nb, Re, C or P-type semiconductor materials.

The cathode material having lower work function is selected from oxide cathode material, atomic film cathode material, thorium-tungsten cathode material, rare earth-molybdenum cathode material or rare earth-tungsten-based scandium-type dispenser cathode material.

The thermionic power supply generation unit includes the insulated shell 10, the thermionic transceiving mixed electrode 1 is located inside the insulated shell 10, and the last-stage receiving electrode 9 is embedded on the insulated shell 10. The structure ensures that the thermionic transceiving mixed electrode 1 and the last-stage receiving electrode 9 work at the same or similar operating temperature, and the last-stage receiving electrode 9 may dissipate heat by means of the heat-dissipation apparatus 17 where the temperature is controllable.

In the thermionic power supply generation unit, the thermionic transceiving mixed electrode 1 is used as the emitting electrode and the intermediate electrodes; the emitting electrode, a plurality of the intermediate electrodes and the last-stage receiving electrode 9 are connected in series successively; namely, the thermoelectric conversion component of the thermionic power generation unit comprises n electrodes in total connected in series successively: the first-stage thermionic transceiving mixed electrode 4, the second-stage thermionic transceiving mixed electrode 5, the third-stage thermionic transceiving mixed electrode 6, the fourth-stage thermionic transceiving mixed electrode 7, the m-stage thermionic transceiving mixed electrode 8 and the last-stage receiving electrode 9, where n=m+1.

A thermionic power supply comprising the foregoing thermionic power supply generation unit includes: the high temperature heat source 13, the thermionic power supply generation unit, the heat-dissipation apparatus 17, the wire 11 and the load 12; the last-stage receiving electrode 9 of the thermionic power supply generation unit is connected with the heat-dissipation apparatus 17 where the heat dissipation is controllable; the high temperature heat source 13 replenishes the insulated shell 10 with heat Qᵢₙ, multi-stage transceiving mixed electrodes directly or indirectly acquire, from the high temperature heat source 13, heat 14 (Q₁˜Qₘ) replenished to the electrodes, heat 14 (Q₁˜Qₘ) ensures that all the electrodes work at the same or similar high temperature condition, and ensures that the surface of the emitting electrode of each transceiving mixed electrode emits thermion at temperature high enough, and then converts heat, on the transceiving mixed electrode, into interelectrode electric potential energy E₁˜Eₘ. The wire 11 connects the first-stage thermionic transceiving mixed electrode 4, the load 12 and the last-stage thermionic receiving electrode 9 into a current circuit outside the thermionic power generation unit. The loop current 16 transmits Peltier heat and impact heat q 15 from the first-stage thermionic transceiving mixed electrode 4, flowing through the second-stage thermionic transceiving mixed electrode 5, the third-stage thermionic transceiving mixed electrode 6, the fourth-stage thermionic transceiving mixed electrode 7, the m-stage thermionic transceiving mixed electrode 8, finally to the last-stage receiving electrode 9; to ensure the temperature of the last-stage receiving electrode 9 not to rise continuously and not to be higher than that of other electrodes, Peltier heat and impact heat q 15 are discharged, by the heat-dissipation apparatus 17 that may control heat dissipation, to outside the insulated shell 10 of the thermionic power generation unit. Electric potential energy E₁˜Eₘ among various-stage electrodes is transmitted through the wire 11 to the load 12, and the load 12 will obtain electric energy Eₒᵤₜ. The thermionic power generation unit works under the condition where various electrodes maintain the same or similar high temperature; or works under the condition where the emitting electrode and the intermediate electrode have the same temperature but the last-stage receiving electrode has a relatively lower temperature; or works at temperature gradients, from high to low successively, where the emitting electrode, various-stage intermediate electrodes, and the last-stage receiving electrode exist; the operating temperature of the emitting electrode and of the intermediate electrode must be kept within a temperature range at which it is capable of thermionic emission with high efficiency.

1. A thermionic power supply generation unit, comprising: m thermionic transceiving mixed electrodes and a last-stage receiving electrode, wherein the m thermionic transceiving mixed electrodes are connected in series successively, and then are connected in series with the last-stage receiving electrode, namely, a thermoelectric conversion component of the thermionic power generation unit comprises n electrodes in total connected in series successively: a first-stage thermionic transceiving mixed electrode, a second-stage thermionic transceiving mixed electrode, a third-stage thermionic transceiving mixed electrode, a fourth-stage thermionic transceiving mixed electrode, an m-stage thermionic transceiving mixed electrode and the last-stage receiving electrode, wherein the m is a natural number, and n=m+1.

2. The thermionic power supply generation unit according to claim 1, wherein the thermionic transceiving mixed electrode is arranged inside an insulated shell, one side of the last-stage receiving electrode is adjacent to the thermionic transceiving mixed electrode, and the other side meets requirements for dissipating heat toward outside the insulated shell where heat dissipation is controllable to ensure that a operating temperature of the last-stage receiving electrode is not higher than that of other transceiving mixed electrodes.

3. The thermionic power supply generation unit according to claim 1, wherein the last-stage receiving electrode is made from a high-melting-point conductor having higher work function and lower capability of thermionic emission; the thermionic transceiving mixed electrode is used as an emitting electrode and an intermediate electrode; the thermionic transceiving mixed electrode uses the high-melting-point point conductor having higher work function as a receiving electrode substrate of the thermionic transceiving mixed electrode, on a structural surface that is of the receiving electrode substrate and that needs thermionic emission, low-work-function material is employed for building a surface of the emitting electrode that is easy of thermionic emission; and on the receiving electrode substrate, except the structural surface that needs thermionic emission, other various external surfaces are not easy of thermionic emission due to higher surface barrier.

4. The thermionic power supply generation unit according to claim 3, wherein material adopted by the receiving electrode substrate of the thermionic transceiving mixed electrode and material adopted by a surface of the emitting electrode meet the following condition: Ø_{C}>Ø_{E}, wherein Ø_{C} is work function of the material of the receiving electrode substrate of the thermionic transceiving mixed electrode, and Ø_{E} is work function of the material of the surface of the emitting electrode of the thermionic transceiving mixed electrode.

5. The thermionic power supply generation unit according to claim 3, wherein the material of the receiving electrode substrate is made from W, Mo, Ta, Ni, Pt, Nb, Re, C or P-type semiconductor materials.

6. The thermionic power supply generation unit according to claim 3, wherein the cathode material used for building the surface of the emitting electrode is selected from oxide cathode material, atomic film cathode material, thorium-tungsten cathode material, rare earth-molybdenum cathode material or rare earth-tungsten-based scandium-type dispenser cathode material.

7. The thermionic power supply generation unit according to claim 2, wherein the last-stage receiving electrode is made from a high-melting-point conductor having higher work function and lower capability of thermionic emission; the thermionic transceiving mixed electrode is used as an emitting electrode and an intermediate electrode; the thermionic transceiving mixed electrode uses the high-melting-point conductor having higher work function as a receiving electrode substrate of the thermionic transceiving mixed electrode, on a structural surface that is of the receiving electrode substrate and that needs thermionic emission, low-work-function material is employed for building a surface of the emitting electrode that is easy of thermionic emission; and on the receiving electrode substrate, except the structural surface that needs thermionic emission, other various external surfaces are not easy of thermionic emission due to higher surface barrier.
